(19) United States
(12) Patent Application Publication
(10) Pub. No.: US 2025/0168097 A1
(43) Pub. Date: May 22, 2025

(54) DETERMINING A STATUS OF A VIRTUAL GATEWAY

(71) Applicant: Charter Communications Operating, LLC, St. Louis, MO (US)

(72) Inventor: Timothy Clark Bleidorn, Colorado Springs, CO (US)

(21) Appl. No.: 18/510,886

(22) Filed: Nov. 16, 2023

(51) Int. Cl. H04L 43/20; H04L 12/66; H04L 43/10

(52) U.S. Cl. CPC H04L 43/20; H04L 12/66; H04L 43/10

(57) ABSTRACT

A bridged gateway coupled to a local area network (LAN) in a premises establishes a layer 2 tunnel with a device that is external to the LAN. The computing device is operable to provide a virtual gateway that provides default gateway functionality to computing devices connected to the LAN. The bridged gateway generates a message for processing by the virtual gateway. The bridged gateway sends the message via the layer 2 tunnel to the computing device for delivery to the virtual gateway. The bridged gateway determines that a reply to the first message from the virtual gateway has not been received within a predetermined period of time, and in response, sends a status message to a second computing device.

### BACKGROUND

It can be desirable for a service provider to move functionality conventionally provided by a router in a subscriber's home to the service provider's network for a variety of reasons, including, for example, to reduce a need to send a technician to a customer premises to diagnose and correct issues, facilitate faster problem resolution, and simplify introducing new features.

### SUMMARY

The examples disclosed herein determine a status of a virtual gateway.

In one implementation a method is provided. The method includes establishing, by a bridged gateway coupled to a local area network (LAN) in a premises, a layer 2 tunnel with a first computing device that is external to the LAN, the first computing device operable to provide a virtual gateway that provides default gateway functionality to computing devices connected to the LAN. The method further includes generating, by the bridged gateway, a first message for processing by the virtual gateway. The method includes sending, by the bridged gateway via the layer 2 tunnel, the first message to the first computing device for delivery to the virtual gateway. The method includes determining, by the bridged gateway, that a reply to the first message from the virtual gateway has not been received within a predetermined period of time. The method includes in response to determining that a reply has not been received within the predetermined period of time, sending a status message to a second computing device.

In another implementation a bridged gateway is provided. The bridged gateway includes a memory, a transceiver operable to be coupled to a local area network (LAN), and a processor device coupled to the memory and the transceiver. The processor device is operable to establish a layer 2 tunnel with a first computing device that is external to the LAN, the first computing device operable to provide a virtual gateway that provides default gateway functionality to computing devices connected to the LAN. The processor device is further operable to generate a first message for processing by the virtual gateway. The processor device is further operable to send, via the layer 2 tunnel, the first message to the first computing device for delivery to the virtual gateway. The processor device is further operable to determine that a reply to the first message from the virtual gateway has not been received within a predetermined period of time. The processor device is further operable to, in response to determining that a reply has not been received within the predetermined period of time, send a status message to a second computing device.

In another implementation a non-transitory computer-readable storage medium is provided. The non-transitory computer-readable storage medium includes executable instructions operable to cause a processor device of a bridged gateway that is coupled to a local area network (LAN) to establish a layer 2 tunnel with a first computing device that is external to the LAN, the first computing device operable to provide a virtual gateway that provides default gateway functionality to computing devices connected to the LAN. The instructions are further operable to cause the processor device to generate a first message for processing by the virtual gateway. The instructions are further operable to cause the processor device to send, via the layer 2 tunnel, the first message to the first computing device for delivery to the virtual gateway. The instructions are further operable to cause the processor device to determine that a reply to the first message from the virtual gateway has not been received within a predetermined period of time. The instructions are further operable to cause the processor device to, in response to determining that a reply has not been received within the predetermined period of time, send a status message to a second computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment suitable for determining a status of a virtual gateway according to one implementation;

FIG. 2 is a flowchart of a method for determining a status of a virtual gateway according to one implementation;

FIGS. 3A-3C illustrate a sequence diagram illustrating messages communicated between and actions taken by certain components illustrated in FIG. 1 to implement determining a status of a virtual gateway according to one implementation; and

FIG. 4 is a block diagram of a bridged gateway suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Devices connected to a local area network (LAN) typically communicate with other devices connected to the same LAN via layer 2 communication protocols, and with devices connected to another LAN via layer 3 communication protocols. Layer 3 protocol communications are facilitated via a gateway router that is typically physically connected to the same LAN and also connected via a wide area network (WAN) interface to another network, such as a network of a service provider that provides broadband access to the entity operating the LAN. The gateway router implements traditional gateway router services, such as dynamic host configuration protocol (DHCP) services for providing network-connected computing devices with internet protocol (IP) addresses as needed, network address translation (NAT) services to translate private IP addresses associated with a subnetwork to a public IP address, Domain Name System (DNS) services for translating a domain name to an IP address, and the like.

A service provider may desire to provide gateway router functionality from a location within the service provider's network rather than from the customer premises. Moving the gateway functionality from the subscriber's physical location to a network gateway router at a service provider's location, sometimes referred to as a “virtual gateway”, may make it easier to support customer issues and reduce the need to send a technician to a customer premises such as a home or business. Virtual gateways may be implemented on a computing device in the service provider's network, such as, by way of non-limiting example, a broadband network gateway (BNG). A BNG may implement multiple virtual gateways, each of which provides default gateway router functionality to a particular customer LAN.

The terms subnetwork, or subnet, will be treated synonymously herein, and refer to a data communications network, often but not necessarily an Ethernet network, wherein each connected computing device on the subnet has an IP address that has the same network address (e.g., network ID), and which utilizes the same subnet mask to determine whether other computing devices are on the same network or are on a different network. Such computing devices may be referred to herein as being “on” or “connected to” or “coupled to” the same subnet. Computing devices on the same subnet can communicate with one another, typically via layer 2 addressing, such as a media access control (MAC) address, without the need for a router. A LAN is an example of a subnet.

Since a virtual gateway is not physically directly connected to the LAN in the same manner as a conventional gateway router, to implement a virtual gateway in a manner that is transparent to devices connected to the LAN, a device on the LAN, such as a bridged gateway, may establish a logical subscriber link (LSL) between the bridged gateway and the BNG on which the virtual gateway executes. The LSL is typically implemented as a layer 2 (over layer 3) tunnel between the bridged gateway and the BNG, such as, by way of non-limiting example, a GRE tunnel. The bridged gateway may send layer 2 frames generated by devices on the LAN to the virtual gateway (via the BNG) via the tunnel, and may receive layer 2 frames generated by the virtual gateway via the tunnel and send the layer 2 frames to a device or devices on the LAN. This is done transparently such that devices on the LAN are unaware that the virtual gateway is not actually directly connected to the same physical network as the devices on the LAN.

When a gateway router is physically located in a premises and it appears the gateway router is not operational, such as, for example computing devices on the LAN have no connectivity to the Internet, or are not being provided gateway router services such as DHCP or DNS services, it is relatively easy for the user to simply reboot the gateway router, which, in many instances may correct the issue. However, this is not possible when the gateway router is a virtual gateway router and is located in the service provider's network. Moreover, if the BNG itself is not operational, the BNG cannot send a status message to a network operations computing device to indicate to an operator that a problem exists. Thus, the service provider may only learn of the problem when an unhappy customer calls the service provider.

The examples disclosed herein determine a status of a virtual gateway, and in some circumstances, send a status message to a computing device, such as a network operations computing device, that identifies the status of the virtual gateway, or of the computing device on which the virtual gateway executes. In particular, a bridged gateway generates a message for processing by a virtual gateway that provides default gateway services to the local area network to which the bridged gateway is connected. The bridged gateway sends the message to a computing device for delivery to the virtual gateway. The bridged gateway determines a post message event comprising one of receiving a message from the virtual gateway and not receiving a message from the virtual gateway within a predetermined period of time, and based on the post message action, generates a status message. The bridged gateway sends the status message to a second computing device. In this manner, the bridged gateway can continuously monitor the status of the virtual gateway and, if a problem arises, immediately inform network operations staff even prior to a customer becoming aware of the problem.

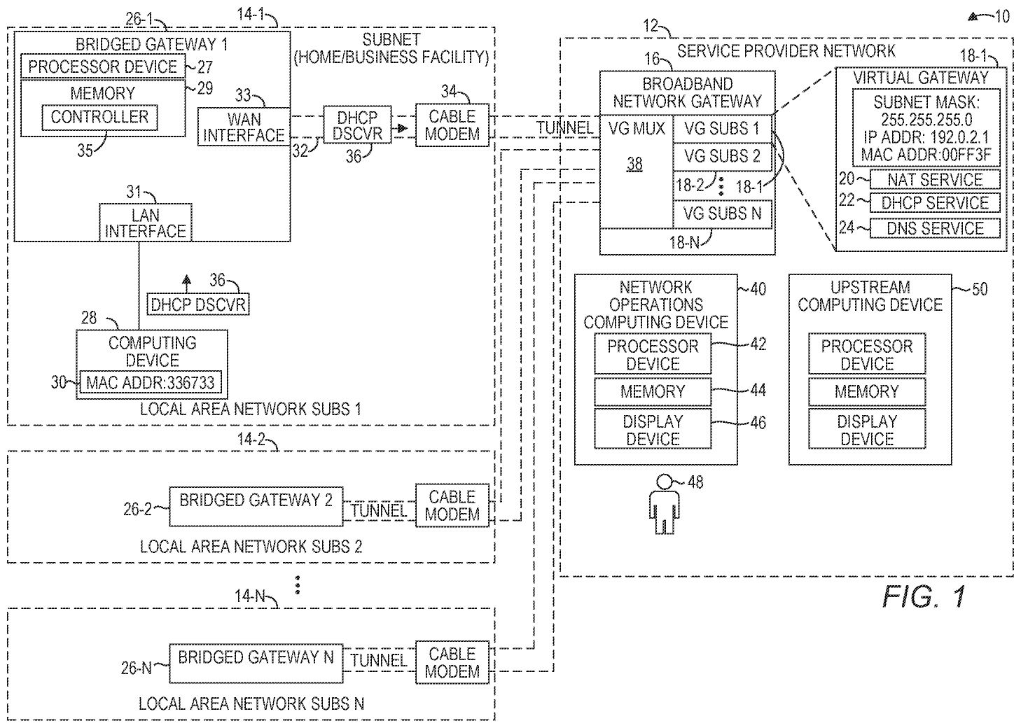

FIG. 1 is a block diagram of an environment 10 suitable for determining a status of a virtual gateway according to one implementation. The environment 10 includes a service provider network 12 and a plurality of local area networks (LANs) 14-1-14-N (generally, LANs 14), located in subscribers' premises, such as businesses or homes. The service provider network 12 includes a broadband network gateway (BNG) 16 that is a computing device that is configured to initiate a plurality of virtual gateways 18-1-18-N (generally, virtual gateways 18) that provide, for the LANs 14-1-14-N, default gateway router functions, such as, by way of non-limiting example, a NAT service 20, a DHCP service 22, a DNS service 24, and a router function to facilitate communication between a computing device connected to a corresponding LAN 14 and a computing device connected to another network. The BNG 16 has an IP address associated with a different network than the LANs 14-1-14-N. The BNG 16 is physically located in a facility controlled by the respective service provider, and may be located tens, hundreds, or thousands of miles from the LANs 14. In some embodiments, the virtual gateways 18 may comprise a virtual gateway as described in TR-317 Network Enhanced Residential Gateway, available at www.broadband-forum.org/download/TR-317.pdf.

The LANs 14-1-14-N each have bridged gateways 26-1-26-N, respectively. The bridged gateway 26-1 includes a processor device 27 and a memory 29 and is coupled to the LAN 14-1 via a layer 2 LAN interface 31, such as an Ethernet wired transceiver, a Wi-Fi transceiver, or both. The bridged gateway 26-1 is a learning bridge and may serve as a Wi-Fi access point and/or a local Ethernet switch. When serving as a Wi-Fi access point the bridged gateway 26-1 may broadcast an SSID to which wireless computing devices may, if properly authenticated, connect. The bridged gateway 26-1 includes a WAN interface 33 via which the bridged gateway 26-1 can communicate with computing devices on networks other than the LAN 14-1. The bridged gateway 26-1 is configured with, or obtains during an initialization stage, an IP address that is associated with the WAN interface 33. The bridged gateway 26-1 implements a transparent tunneling mechanism with the BNG 16 via the WAN interface 33 as will be described in greater detail below. The bridged gateway 26-1 may initiate a controller 35 that implements some of the functionality described herein. The controller 35 is operable to generate and cause layer 2 frames to be transmitted via the layer 2 tunnel 32 for processing by the virtual gateway 18-1, and to generate and cause TCP/IP packets to be transmitted via the WAN interface 33 outside of the layer 2 tunnel 32 to computing devices, including the BNG 16. It is noted, however, because the controller 35 is a component of the bridged gateway 26-1, functionality implemented by the controller 35 may be attributed to the bridged gateway 26-1 generally. Moreover, in examples where the controller 35 comprises software instructions that program the processor device 27 to carry out functionality discussed herein, functionality implemented by the controller 35 may be attributed herein to the processor device 27.

During an initialization stage of the bridged gateway 26-1, the bridged gateway 26-1 establishes a layer 2 (via layer 3) tunnel 32 with the BNG 16 via the WAN interface 33. It is noted that there may be one or more computing devices between the bridged gateway 26-1 and the BNG 16 such as, by way of non-limiting example, a cable modem 34 and a CMTS (not illustrated). The tunneling protocol may comprise any suitable tunneling protocol; however, in some embodiments, the tunneling protocol comprises a layer 2 tunneling protocol such as, by way of non-limiting example, the generic routing encapsulation (GRE) tunneling protocol. The bridged gateway 26-1 and the BNG 16 use their respective IP addresses to establish the layer 2 (over layer 3) tunnel 32. There may be any number of devices between the bridged gateway 26-1 and the BNG 16, such as, by way of non-limiting example, the cable modem 34 and one or more switching devices (not illustrated) in the service provider network 12. In some implementations the bridged gateway 26-1 and the BNG 16 may utilize encryption to encrypt the data sent over the layer 2 tunnel 32.

As an example of the functioning of the bridged gateway 26-1, at some point in time the computing device 28 connects to the LAN 14-1 via the LAN interface 31. The connection may be wireless or wired, such as via an ethernet cable. The connection process may be initiated in response to powering on the computing device 28, or, in the case of a Wi-Fi connection, by providing the appropriate authentication credentials to the bridged gateway 26-1 where the bridged gateway 26-1 also serves as a Wi-Fi access point.

The computing device 28 initiates a sequence to obtain an IP address and other information necessary to communicate with other computing devices. The sequence begins with the computing device 28 broadcasting a DHCP Discover message 36 (e.g., transmitting the DHCP Discover message to a broadcast destination address). The bridged gateway 26-1 receives the DHCP Discover message 36. The bridged gateway 26-1 analyzes the DHCP Discover message 36 and determines that the DHCP Discover message is a DHCP Discover message. The bridged gateway 26-1 sends, to the BNG 16 via the layer 2 tunnel 32, the DHCP Discover message 36.

A virtual gateway multiplexer 38 determines that the virtual gateway 18-1 provides default gateway services for the LAN 14-1, and sends the DHCP Discover message 36 to the virtual gateway 18-1 for processing. The virtual gateway 18-1 receives the DHCP Discover message 36. The virtual gateway 18-1 then generates a DHCP Offer message. The BNG 16 encapsulates the DHCP Offer message into a layer 3 protocol, such as TCP/IP, and sends the DHCP Offer message to the bridged gateway 26-1 via the tunnel 32. The bridged gateway 26-1 extracts the DHCP Offer message from the layer 3 protocol and sends the DHCP Offer message to the computing device 28 using the MAC address of the virtual gateway 18-1 as the originator of the layer 2 frame. The computing device 28 receives the DHCP Offer message, and the computing device 28 and virtual gateway 18-1 finalize the four message DHCP sequence (e.g., Discover, Offer, Request, Ack). At the end of the sequence the computing device 28 has an IP address and a subnet mask that the computing device 28 uses to determine if an IP address of a destination device is on the LAN 14-1 or is on another network.

Subsequently, assume that the computing device 28 desires to send a packet to a computing device that is not on the LAN 14-1. The computing device 28 addresses the packet to the virtual gateway 18-1 using the MAC address of the virtual gateway 18-1 because the virtual gateway 18-1 identified itself to the computing device 28 as the default gateway router for the computing device 28 during the DHCP process.

The bridged gateway 26-1 receives the packet, determines that the packet is addressed to the virtual gateway 18-1, encapsulates the packet in the layer 3 protocol and sends the packet to the BNG 16 via the tunnel 32. The virtual gateway multiplexer 38 receives the packet, determines that the packet is destined for the virtual gateway 18-1, and sends the packet to the virtual gateway 18-1. The virtual gateway 18-1 forwards the packet from the computing device 28 to a router based on routing tables maintained by the virtual gateway 18-1 in the same manner as a conventional gateway router.

The bridged gateway 26-1 forwards all layer 2 frames generated by a computing device 28 on the LAN 14-1 that have a destination address of the virtual gateway 18-1 and all broadcast layer 2 frames to the virtual gateway 18-1. To the computing device 28, the virtual gateway 18-1 appears to be directly coupled to the LAN 14-1. The bridged gateways 26-2-26-N operate substantially similarly to the bridged gateway 26-1.

The service provider network 12 includes a network operations computing device 40 that includes a processor device 42, a memory 44 and a display device 46. An operator 48 may interact with the network operations computing device 40 to manage and control the service provider network 12. The service provider network 12 also includes an upstream computing device 50 that is upstream of the BNG 16. Upstream in this context means that the upstream computing device 50 resides in a communications path between the BNG 16 and other computing devices external to the service provider network 12, such as the Internet, such that packets processed by the BNG 16 that are destined for the Internet travel through the upstream computing device 50.

The controller 35 may generate or cause a message (e.g., a layer 2 frame) to be generated for processing by the virtual gateway 18-1. By “generate” it is meant that the message originates from the bridged gateway 26-1 rather than from a computing device connected to the LAN 14-1, such as the computing device 28. The controller 35 may generate such a message periodically, intermittently, in response to some event or condition, or in response to an instruction from the network operations computing device 40 to provide the status of the virtual gateway 18-1. The controller 35 causes the bridged gateway 26-1 to send the message via the layer 2 tunnel to the BNG 16 for delivery to the virtual gateway 18-1. In some implementations the controller 35 may use a DHClient command to obtain an IP address to cause the generation of the message. In some implementations the message may comprise a DHCP Discover message, however, any suitable message that would cause a gateway router to respond may be generated and sent. The DHCP Discover message or other message may comprise a MAC source address generated by the bridged gateway 26-1.

Subsequent to sending the message to the virtual gateway 18-1, the controller 35 waits a predetermined period of time for the virtual gateway 18-1 to send a reply to the message. The predetermined period of time may be hard-coded or operator configurable, and may comprise, by way of non-limiting example, 10 milliseconds, 100 milliseconds, a second, or any other suitable or desirable amount of time. If the controller 35 receives a reply to the message, the controller 35 may determine that the virtual gateway 18-1 is operational and do nothing else, or may generate and send a status message to a destination, such as the network operations computing device 40. The controller 35 may repeat this process periodically, such as every second, every five seconds, every 10 seconds, or the like to continuously monitor the status of the virtual gateway 18-1.

If, after the predetermined amount of time, the controller 35 has not received a reply to the message, the controller 35 sends a status message to a destination, such as the network operations computing device 40. The status message may indicate that the BNG 16 or the virtual gateway 18-1 is not responding. In some implementations, prior to sending the status message, the controller 35 may send a PING command to the BNG 16 via the WAN interface 33. The PING command may be sent outside of the layer 2 tunnel 32. The controller 35 may then determine a post PING event comprising one of receiving a response to the PING command and not receiving a response to the PING command within a predetermined period of time. If the controller 35 receives a response to the PING command, the controller 35 may include in the status message information indicating that the BNG 16 is reachable but not responding.

If the controller 35 does not receive a response to the PING command within the predetermined period of time, the controller 35 may include in the status message information indicating that the BNG 16 is not reachable. This could be due, for example, to a network fault in between the bridged gateway 26-1 and the BNG 16 or because the BNG 16 has gone down.

In some implementations, after the controller 35 receives a reply from the virtual gateway 18-1, indicating that the virtual gateway 18-1 and the BNG 16 are operational, the controller 35 may send a PING command to an upstream device, such as the upstream computing device 50, or send a message to a predetermined server on the Internet. If the controller 35 does not receive a response within a predetermined amount of time, the controller 35 may generate and send a status message that indicates that the BNG 16 and the virtual gateway 18-1 are operational, but that the Internet is not reachable.

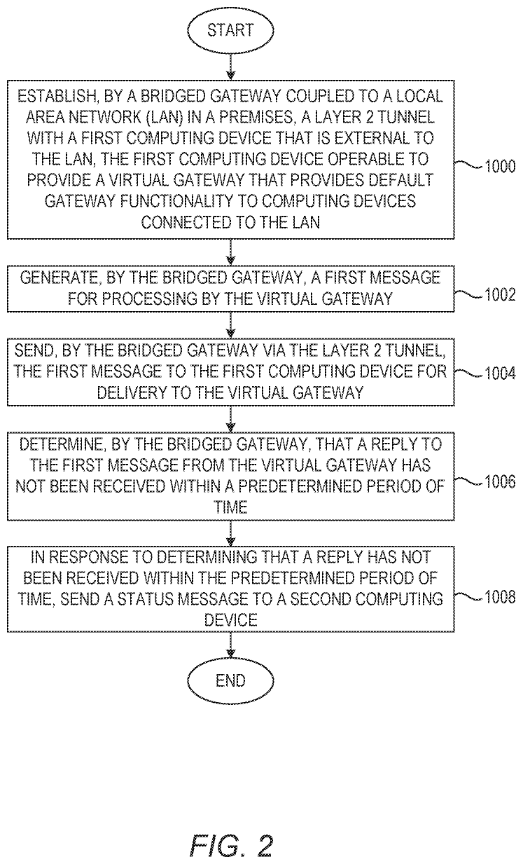

FIG. 2 is a flowchart of a method for determining a status of a virtual gateway according to one implementation. FIG. 2 will be discussed in conjunction with FIG. 1. The bridged gateway 26-1, coupled to the LAN 14-1 in a premises, the layer 2 tunnel 32 with a computing device such as the BNG 16 that is external to the LAN 14-1. The term “external to the LAN 14-1” refers to the BNG 16 being on a different network than the LAN 14-1 (i.e., the network identifier (ID) portion of the IP address of the BNG 16 is different from the network ID of the LAN 14-1). The BNG 16 is operable to provide the virtual gateway 18-1 that provides default gateway functionality to computing devices connected to the LAN 14-1 (FIG. 2, block 1000). The bridged gateway 26-1 generates a message for processing by the virtual gateway 18-1 (FIG. 2, block 1002). The message may comprise a layer 2 broadcast frame, such as a DHCP Discover message. The bridged gateway 26-1 may generate and insert a media access control (MAC) address into the layer 2 broadcast frame. The bridged gateway 26-1 sends, via the layer 2 tunnel 32, the message to the BNG 16 for delivery to the virtual gateway 18-1 (FIG. 2, block 1004). The bridged gateway 26-1 determines that a reply to the message from the virtual gateway 18-1 has not been received within a predetermined period of time (FIG. 2, block 1006). The bridged gateway 26-1, in response to determining that a reply has not been received within the predetermined period of time, sends a status message to the network operations computing device 40 (FIG. 2, block 1008).

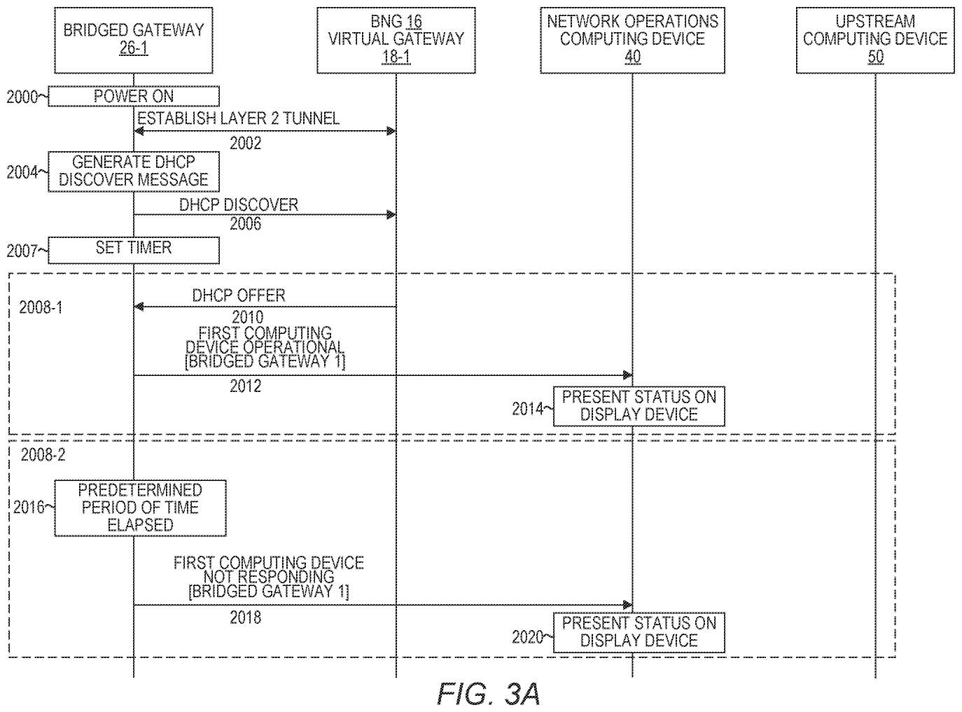

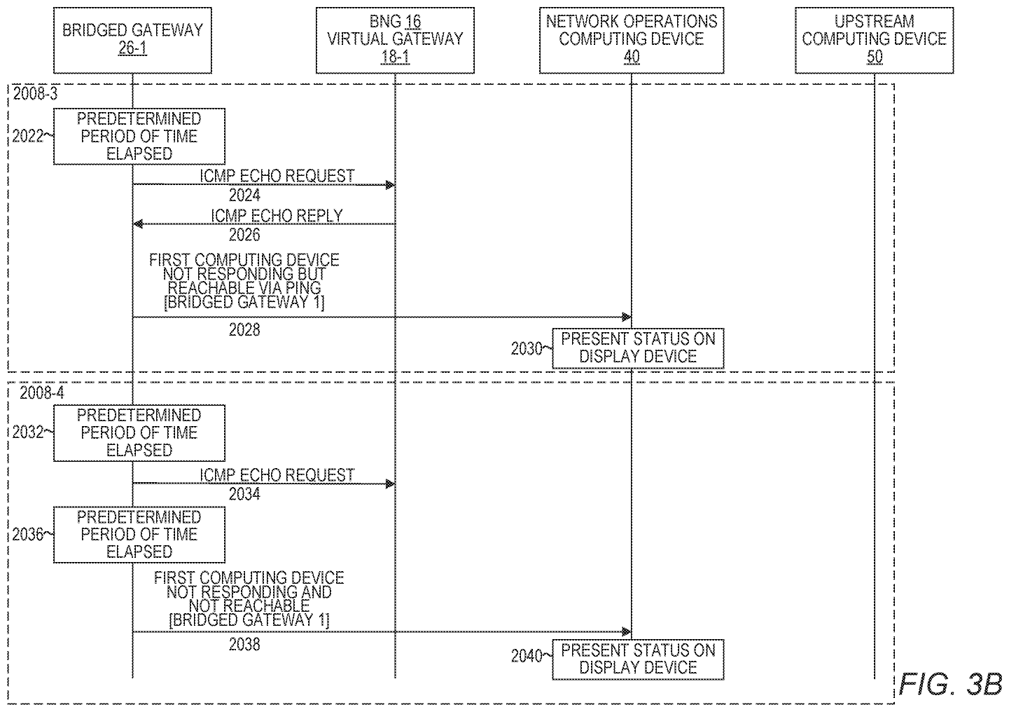

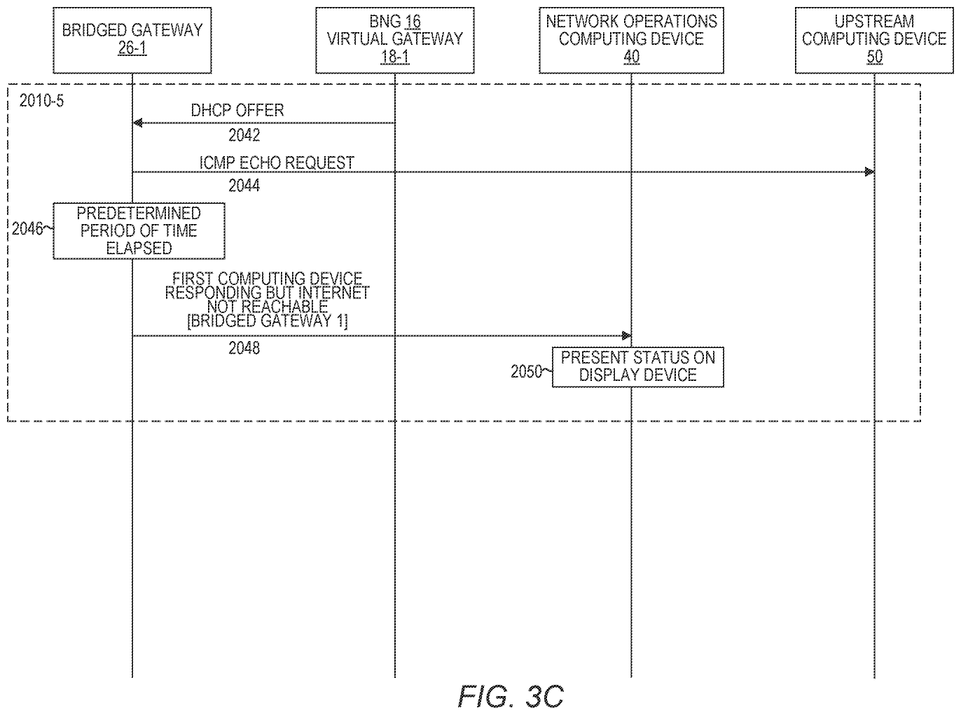

FIGS. 3A-3C illustrate a sequence diagram illustrating messages communicated between and actions taken by certain components illustrated in FIG. 1 to implement determining a status of a virtual gateway according to one implementation. The bridged gateway 26-1 is powered on (FIG. 3A, step 2000). During the initialization phase, the bridged gateway 26-1 establishes a layer 2 tunnel with the BNG 16 (FIG. 3A, step 2002). The layer 2 tunnel may comprise, for example, a GRE tunnel. In some implementations, the bridged gateway 26-1 may be preconfigured with an IP address of the BNG 16, or the bridged gateway 26-1 may, during the initialization phase, issue a query to a known IP address to determine an IP address of the BNG 16.

The bridged gateway 26-1 generates, in this example, a DHCP Discover message and puts the DHCP Discover message into a layer 2 frame (FIG. 3A, step 2004). Thus, the DHCP Discover message is not received by the bridged gateway 26-1 from a computing device connected to the LAN 14-1 or otherwise, the bridged gateway 26-1 itself generates the DHCP Discover message. The bridged gateway 26-1 may generate a random MAC address as the source MAC address of the layer 2 frame. The bridged gateway 26-1 encapsulates the DHCP Discover message layer 2 frame into a TCP/IP packet and sends the TCP/IP packet to the BNG 16 via the layer 2 tunnel 32 for delivery to the virtual gateway 18-1 (FIG. 3A, step 2006). The bridged gateway 26-1 may set a timer to a predetermined amount of time (FIG. 3A, step 2007).

Multiple scenarios may now occur. In a first scenario 2008-1, the BNG 16 extracts the DHCP Discover message the TCP/IP packet and delivers the DHCP Discover message to the virtual gateway 18-1. The virtual gateway 18-1 processes the DHCP Discover message and sends a DHCP Offer message to the bridged gateway 26-1 via the layer 2 tunnel (FIG. 3A, step 2010). The bridged gateway 26-1 receives the message prior to the timer expiring. The bridged gateway 26-1 generates a status message that indicates that the BNG 16 and/or the virtual gateway 18-1 is operational and sends the status message to a destination, such as, for example, the network operations computing device 40 (FIG. 3A, step 2012). In each of the status messages discussed herein, the status message may identify the BNG 16 and/or the virtual gateway 18-1 in some manner, such as via IP address, predetermined identifier, or the like. The status message may also identify the bridged gateway 26-1 in some manner, such as via the IP address of the bridged gateway 26-1, a predetermined identifier, or the like. The network operations computing device 40 may present the contents of the status message on the display device 46 (FIG. 3A, step 2014).

In another scenario 2008-2, subsequent to step 2007, the timer set by the bridged gateway 26-1 expires prior to receiving a response from the virtual gateway 18-1 (FIG. 3A, step 2016). The bridged gateway 26-1 generates a status message that indicates that the BNG 16 and/or the virtual gateway 18-1 is not responding and sends the status message to a destination, such as, for example, the network operations computing device 40 (FIG. 3A, step 2018). The network operations computing device 40 may present the contents of the status message on the display device 46 to alert the operator 48 that there is a problem with the BNG 16 or the virtual gateway 18-1, and the operator 48 may perform additional actions to rectify the problem even prior to a customer being aware of the problem (FIG. 3A, step 2020).

Referring now to FIG. 3B, in another scenario 2008-3, subsequent to step 2007, the timer set by the bridged gateway 26-1 expires prior to receiving a response from the virtual gateway 18-1 (FIG. 3B, step 2022). The bridged gateway 26-1 issues a PING command (i.e., sends or causes to be sent an ICMP echo request) to the BNG 16 and sets and starts the timer (FIG. 3B, step 2024). The PING command may be sent outside of the layer 2 tunnel 32. Prior to the timer expiring, the BNG 16 responds with an ICMP Echo reply (FIG. 3B, step 2026). The bridged gateway 26-1 generates a status message that indicates that the BNG 16 is reachable but that the virtual gateway 18-1 is not responding and sends the status message to the network operations computing device 40 (FIG. 3B, step 2028). The network operations computing device 40 may present the contents of the status message on the display device 46 to alert the operator 48 that there is a problem with the virtual gateway 18-1 (FIG. 3B, step 2030). In this scenario, the operator 48 is now aware that the problem is likely not the BNG 16 itself, but rather the virtual gateway 18-1 that has become non-operational.

In another scenario 2008-4, subsequent to step 2007, the timer set by the bridged gateway 26-1 expires prior to receiving a response from the virtual gateway 18-1 (FIG. 3B, step 2032). The bridged gateway 26-1 issues a PING command (i.e., sends or causes to be sent an ICMP echo request) to the BNG 16 and sets and starts the timer (FIG. 3B, step 2034). The timer expires prior to receiving a reply from the BNG 16 (FIG. 3B, step 2036). The bridged gateway 26-1 generates a status message that indicates that the BNG 16 is not responding and the virtual gateway 18-1 is not responding and sends the status message to the network operations computing device 40 (FIG. 3B, step 2038). The network operations computing device 40 may present the contents of the status message on the display device 46 to alert the operator 48 that there is a problem with the BNG 16 (FIG. 3B, step 2040).

Referring now to FIG. 3C, in another scenario 2008-5, subsequent to step 2007, the BNG 16 extracts the DHCP Discover message from the TCP/IP packet and delivers the DHCP Discover message to the virtual gateway 18-1. The virtual gateway 18-1 processes the DHCP Discover message and sends a DHCP Offer message to the bridged gateway 26-1 via the layer 2 tunnel (FIG. 3C, step 2042). The bridged gateway 26-1 receives the message prior to the timer expiring. The bridged gateway 26-1 issues a PING command (i.e., sends or causes to be sent an ICMP echo request) to the upstream computing device 50 and sets and starts the timer (FIG. 3C, step 2044). The PING command may be sent outside of the layer 2 tunnel 32. The timer expires prior to receiving a reply from the upstream computing device 50 (FIG. 3C, step 2046). The bridged gateway 26-1 generates a status message that indicates that the BNG 16 is responding but that the Internet is not reachable and sends the status message to the network operations computing device 40 (FIG. 3C, step 2048). The network operations computing device 40 may present the contents of the status message on the display device 46 to alert the operator 48 that there is a problem upstream of the BNG 16 (FIG. 3C, step 2050).

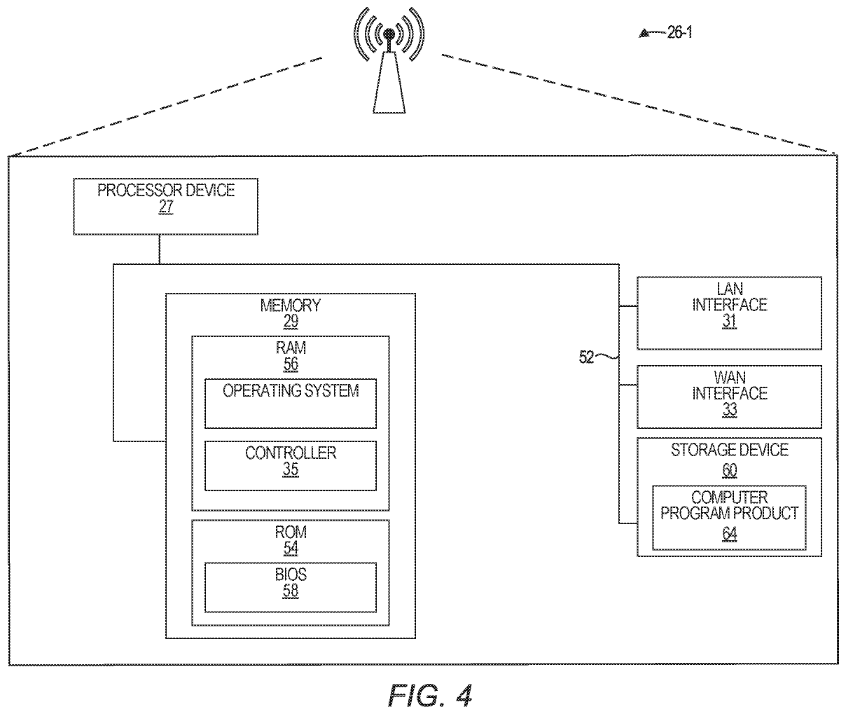

FIG. 4 is a block diagram of the bridged gateway 26-1 suitable for implementing examples disclosed herein. The bridged gateway 26-1 may comprise a learning bridge and a Wi-Fi access point. In some implementations the bridged gateway 26-1 may comprise a multi-modal device that in one mode is a gateway router and in another mode a learning bridge. The bridged gateway 26-1 includes the processor device 27, the system memory 29, and a system bus 52. The system bus 52 provides an interface for system components including, but not limited to, the system memory 29 and the processor device 27. The processor device 27 can be any commercially available or proprietary processor.

The system bus 52 may be any of several types of bus structures that may further interconnect to a memory bus (with or without a memory controller), a peripheral bus, and/or a local bus using any of a variety of commercially available bus architectures. The system memory 29 may include non-volatile memory 54 (e.g., read-only memory (ROM), erasable programmable read-only memory (EPROM), electrically erasable programmable read-only memory (EEPROM), etc.), and volatile memory 56 (e.g., random-access memory (RAM)). A basic input/output system (BIOS) 58 may be stored in the non-volatile memory 54 and can include the basic routines that help to transfer information between elements within the bridged gateway 26-1. The volatile memory 56 may also include a high-speed RAM, such as static RAM, for caching data.

The bridged gateway 26-1 may further include or be coupled to a non-transitory computer-readable storage medium such as a storage device 60, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 60 and other drives associated with computer-readable media and computer-usable media may provide non-volatile storage of data, data structures, computer-executable instructions, and the like.

A number of modules can be stored in the storage device 60 and in the volatile memory 56, including an operating system and one or more program modules, such as the controller 35, which may implement the functionality described herein in whole or in part. All or a portion of the examples may be implemented as a computer program product 64 stored on a transitory or non-transitory computer-usable or computer-readable storage medium, such as the storage device 60, which includes complex programming instructions, such as complex computer-readable program code, to cause the processor device 27 to carry out the steps described herein. Thus, the computer-readable program code can comprise software instructions for implementing the functionality of the examples described herein when executed on the processor device 27. The processor device 27, in conjunction with the controller 35 in the volatile memory 56, may serve as a controller, or control system, for the bridged gateway 26-1 that is to implement the functionality described herein.

The bridged gateway 26-1 may have a number of communication interfaces including, for example, one or more LAN interfaces 31 to which a computing device, such as the computing device 28, can be connected via an appropriate cable or wireless protocol. The bridged gateway 26-1 includes the WAN interface 33 via which the bridged gateway 26-1 may be coupled to the cable modem 34 and thereby communicate with computing devices on other networks, such as the BNG 16.

Individuals will recognize improvements and modifications to the preferred examples of the disclosure. All such improvements and modifications are considered within the scope of the concepts disclosed herein and the claims that follow.

What is claimed is:

1. A method, comprising:
establishing, by a bridged gateway coupled to a local area network (LAN) in a premises, a layer 2 tunnel with a first computing device that is external to the LAN, the first computing device operable to provide a virtual gateway that provides default gateway functionality to computing devices connected to the LAN;
generating, by the bridged gateway, a first message for processing by the virtual gateway;
sending, by the bridged gateway via the layer 2 tunnel, the first message to the first computing device for delivery to the virtual gateway;
determining, by the bridged gateway, that a reply to the first message from the virtual gateway has not been received within a predetermined period of time; and
in response to determining that a reply has not been received within the predetermined period of time, sending a status message to a second computing device.

2. The method of claim 1, wherein the bridged gateway comprises a wide-area network (WAN) interface and a LAN interface, and an internet protocol address associated with the WAN interface.

3. The method of claim 2, wherein the layer 2 tunnel is established via the WAN interface.

4. The method of claim 1, wherein the status message comprises information indicating that the first computing device or the virtual gateway is not responding.

5. The method of claim 1, further comprising:
sending, by the bridged gateway to the first computing device, a PING command; and
determining, by the bridged gateway, a post PING event comprising one of receiving a response to the PING command and not receiving a response to the PING command within a predetermined period of time.

6. The method of claim 5, wherein the post PING event further comprises receiving the response to the PING command, and wherein the status message comprises information indicating that the first computing device is reachable but not responding.

7. The method of claim 5, wherein the post PING event comprises not receiving the response to the PING command within the predetermined period of time, and wherein the status message comprises information indicating that the first computing device is not reachable.

8. The method of claim 1, further comprising:
receiving, by the bridged gateway from the second computing device, an instruction to provide a status of the virtual gateway; and
in response to receiving the instruction, generating the first message for processing by the virtual gateway.

9. The method of claim 1, further comprising:
receiving, by the bridged gateway from the second computing device, an instruction to provide a status of the virtual gateway;
in response to receiving the instruction, generating, by the bridged gateway, a second message for processing by the virtual gateway;
sending, by the bridged gateway via the layer 2 tunnel, the second message to the first computing device for delivery to the virtual gateway;
determining, by the bridged gateway, that a reply to the second message from the virtual gateway has been received within the predetermined period of time; and
in response to determining that the reply has been received within the predetermined period of time, sending a status to the second computing device, the status indicating that the virtual gateway is operational.

10. The method of claim 1, further comprising:
receiving, by the bridged gateway, a DHCP Discover message from a second computing device connected to the LAN;
determining, by the bridged gateway, that the DHCP Discover message is a message to be processed by the virtual gateway;
encapsulating the DHCP Discover message into a layer 3 protocol; and
sending the DHCP Discover message to the first computing device via the layer 2 tunnel.

11. The method of claim 10, further comprising:
receiving, by the bridged gateway via the layer 2 tunnel, a layer 3 packet that includes a layer 2 reply to the DHCP Discover message from the virtual gateway;
extracting, by the bridged gateway, the layer 2 reply; and
sending by the bridged gateway to the second computing device, the layer 2 reply, the layer 2 reply comprising a source media access control address of the virtual gateway.

12. A bridged gateway, comprising:
a memory;
a transceiver operable to be coupled to a local area network (LAN); and
a processor device coupled to the memory and the transceiver and being operable to:
establish a layer 2 tunnel with a first computing device that is external to the LAN, the first computing device operable to provide a virtual gateway that provides default gateway functionality to computing devices connected to the LAN;
generate a first message for processing by the virtual gateway;
send, via the layer 2 tunnel, the first message to the first computing device for delivery to the virtual gateway;
determine that a reply to the first message from the virtual gateway has not been received within a predetermined period of time; and
in response to determining that a reply has not been received within the predetermined period of time, send a status message to a second computing device.

13. The bridged gateway of claim 12, wherein the processor device is further operable to:
send, to the first computing device, a PING command; and
determine a post PING event comprising one of receiving a response to the PING command and not receiving a response to the PING command within a predetermined period of time.

14. The bridged gateway of claim 13, wherein the post PING event further comprises receiving the response to the PING command, and wherein the status message comprises information indicating that the first computing device is reachable but not responding.

15. The bridged gateway of claim 13, wherein the post PING event comprises not receiving the response to the PING command within the predetermined period of time, and wherein the status message comprises information indicating that the first computing device is not reachable.

16. The bridged gateway of claim 12, wherein the bridged gateway comprises a wide-area network (WAN) interface and a LAN interface.

17. A non-transitory computer-readable storage medium that includes executable instructions operable to cause a processor device of a bridged gateway that is coupled to a local area network (LAN) to:
establish a layer 2 tunnel with a first computing device that is external to the LAN, the first computing device operable to provide a virtual gateway that provides default gateway functionality to computing devices connected to the LAN;
generate a first message for processing by the virtual gateway;
send, via the layer 2 tunnel, the first message to the first computing device for delivery to the virtual gateway;
determine that a reply to the first message from the virtual gateway has not been received within a predetermined period of time; and
in response to determining that a reply has not been received within the predetermined period of time, send a status message to a second computing device.

18. The non-transitory computer-readable storage medium of claim 17, wherein the instructions are further operable to cause the processor device to:
send, to the first computing device, a PING command; and
determine a post PING event comprising one of receiving a response to the PING command and not receiving a response to the PING command within a predetermined period of time.

19. The non-transitory computer-readable storage medium of claim 18, wherein the post PING event further comprises receiving the response to the PING command, and wherein the status message comprises information indicating that the first computing device is reachable but not responding.

20. The non-transitory computer-readable storage medium of claim 18, wherein the post PING event comprises not receiving the response to the PING command within the predetermined period of time, and wherein the status message comprises information indicating that the first computing device is not reachable.
